(19) United States
(12) Patent Application Publication
(10) Pub. No.: US 2008/0252235 A1
(43) Pub. Date: Oct. 16, 2008

(54) Electronic Control Gear and Method of its Use

(76) Inventors: Neil Dudley, Chelmsford (GB); Bernhard Pfeiffer, Berlin (DE); Phil Houghton, Essex (GB); Gerold Malin, Kalfenleutgeben (AT); Guido Heremans, Rofselaar (BE)

Correspondence Address: BARLEY SNYDER, LLC, 1000 WESTLAKES DRIVE, SUITE 275, BERWYN, PA, 19312, US

(21) Appl. No.: 12/067,015

(22) PCT Filed: Sep. 15, 2006
(86) PCT No.: PCT/GB06/03429

§ 371 Date: Mar. 14, 2008

(30) Foreign Application Priority Data
Sep. 15, 2005 (GB) 0518790.1

(51) Int. Cl. H05B 41/36

(52) U.S. Cl. 315/307

(57) ABSTRACT

An electronic control gear for a lamp is disclosed. The electronic control gear has a memory device and a microprocessor configured to acquire data relating to at least one parameter of operation of the lamp and configured to store acquired data in the memory device. The at least one parameter of operation is an electrical power consumption of the lamp during a period of operation, a duration of operation of the lamp during a period, a duration of operation the lamp at each of a plurality of power consumption levels or bands, or an operating temperature of a component of a circuit in which the lamp is connected.

### CROSS-REFERENCE TO RELATED APPLICATION DATA

This application claims the benefit of the earlier filed International Patent Application No. PCT/GB2006/003429 which has a filing date of Sep. 15, 2006 and claims the benefit of British Patent Application No. GB 0518790.1 which has a filing date of Sep. 15, 2005.

### FIELD OF THE INVENTION

This invention relates to the field of electronic control gears.

### BACKGROUND

In the field of street or area lighting, it is known to employ gas discharge lamps such as but not limited to high pressure sodium lamps. Such devices are desirable because of their high lumen efficiency values. A gas discharge lamp requires a control gear including a ballast and an igniter circuit. Electromagnetic ballasts are well known, but suffer from numerous disadvantages including significant losses, no way of tracking likely end of life of lamps and igniters connected to such ballasts, flickering or cycling between on and off states at or near end of life, and lumen outputs that are related to the input voltage to the ballast. In view of these disadvantages, so-called microprocessor control gears have been developed.

These solve the majority of the problems identified above, and additionally may offer desirable control options such as the ability to adjust the light output of a discharge lamp continuously over a range of lumen values.

However, the microprocessor control gears typically include an electronic ballast whose operating life is sensitive to ambient temperatures. Thus, if an electronic ballast forming part of a microprocessor control gear operates in ambient conditions exceeding a recommended maximum temperature value, the electronic ballast may fail prematurely. This may lead to undesirable disputes between an operator of a street lighting network and a supplier of the control gears, since it is impossible for the supplier of such control gears to establish, from a remote location, the ambient temperatures which a failed control gear has encountered.

A further problem associated with the use of microprocessor control gears is that the utility companies which supply electric power to area and street lighting networks often only record imprecise data about power consumption levels, and in many cases record no data at all. This makes it difficult for operators of street lighting networks successfully to argue, on the basis of data provided by the utility companies, that they are entitled to reductions in the costs of the power supplied, or that they are not operating their networks outside the terms of supply agreements.

### SUMMARY

The present invention relates to, in one embodiment among others, an electronic control gear for a lamp. The electronic control gear has a memory device and a microprocessor configured to acquire data relating to at least one parameter of operation of the lamp and configured to store acquired data in the memory device. The at least one parameter of operation is an electrical power consumption of the lamp during a period of operation, a duration of operation of the lamp during a period, a duration of operation the lamp at each of a plurality of power consumption levels or bands, or an operating temperature of a component of a circuit in which the lamp is connected.

### BRIEF DESCRIPTION OF THE DRAWINGS

There now follows a description of a preferred embodiment of the invention, by way of non-limiting example, with reference being made to the accompanying drawing which is a schematic representation of an electronic control gear according to the invention.

FIG. 1 is a simplified block diagram of an electronic control gear according to an embodiment of the present invention.

### DETAILED DESCRIPTION OF THE EMBODIMENTS

In view of the nature of the invention defined herein, the following is a description of both the arrangement (hardware) of an electronic control gear, and its method of use or operation.

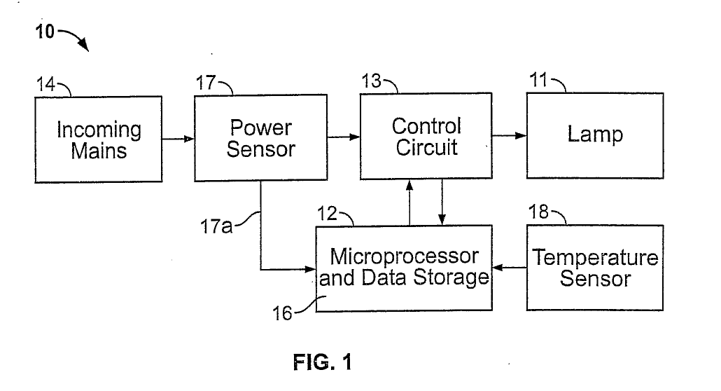

Referring to FIG. 1, an electronic control gear 10 is connected to control the operation of one or more lamps 11, in this embodiment, each configured as a gas discharge lamp. In the arrangement of FIG. 1, a microprocessor 12 is operatively connected to permit two-way data and command communication to a control circuit 13 containing an electrical power control device.

Incoming mains power 14, represented schematically, is supplied via the control circuit 13 to the lamp 11, in a manner such that in dependence on command signals generated by the microprocessor 12, the voltage and current applied to the lamp 11 are maintained as far as possible at predetermined levels.

The control gear 10 additionally includes a memory device 16 that in the embodiment shown is configured as part of the same package as the microprocessor 12. This however need not necessarily be so, it being sufficient merely for the memory device 16 to be operatively connectable to the microprocessor 12 for the purpose of transfer and storage of data.

The microprocessor 12 is a programmable device that in accordance with the invention is configured to acquire data relating to one or more of the following parameters of operation for the lamp 11 or each lamp 11 in an area or street lighting network:
the electrical power consumption of lamps 11, during a period of use;
the duration of operation of one or more lamps 11 during a period as defined herein;
the duration of operation of one or more lamps 11 at each of a plurality of power consumption levels or bands; and/or
the operating temperature of one or more components of a circuit in which a said lamp 11 is connected.

To this end, the control gear 10 includes a power sensor 17 that is connected by a connection 17a, as signified by an arrow, to measure the power supplied to the control circuit 13. As signified by the direction of the arrow representing connection 17a, power sensor 17 conveys data relating to parameters (i)-(iii) above to the microprocessor 12.

The control gear 10 additionally includes a temperature sensor 18 that is connected to supply to the microprocessor 12 data on the ambient temperature in which the electronic ballast forming part of the control gear 10 operates. The temperature sensor 18 may be a thermister, an integrated circuit temperature sensor, or any other known design. The output of the temperature sensor 18 may be an analogue or digital signal. The microprocessor 12 preferably implements an algorithm that translates the output of the temperature sensor 18 to units of temperature measurement or quantities related to such units.

The microprocessor 12 operates to store data acquired from the power sensor 17, control circuit 13, and/or temperature sensor 18 in the memory device 16. In this regard, it is not essential that both the power sensor 17 and the temperature sensor 18 are present in an embodiment according to the invention. Only one or both of these components may be present in order to provide the advantages of the invention.

The microprocessor 12 and power sensor 17 are arranged in certain embodiments of the invention to acquire and store data on the duration of operation of one or more of the lamps 11 at each of a plurality of power consumption levels or bands. This feature is of most utility in the case of a control gear 10 that is capable of providing electrical power within such bands to the lamps 11.

The microprocessor 12 includes a clock that generates periodic clock pulse signals. The microprocessor 12 allocates selected said clock pulse signals to define a counter that measures the duration of operation of one or more lamps 11 according to a parameter as defined herein.

The memory device 16 typically includes a non-volatile memory such as an EEPROM (electronically erasable programmable read only memory), a flash memory or a FRAM (ferro-electric random access memory).

In one embodiment of the invention, the microprocessor 12 is programmed or otherwise configured to cause the clock pulse signals to initiate the storage of data in the non-volatile memory device 16 at predetermined intervals (for example every 5 minutes).

Alternatively, the electronic power sensor 17 is capable of generating a power loss signal that is indicative of the loss of incoming mains power 14 to one or more lamps 11. The control gear 10 is capable of transmitting the power loss signal via the connection 17a to the microprocessor 12 which, depending on the type of non-volatile memory employed, may effect storage of data on the power consumption and/or ambient temperature parameters of the control gear 10 in the non-volatile memory device 16 on receipt of the power loss signal.

In either case, the electronic control gear 10 is capable of storing in an inviolable manner recent data relating to the recorded parameters as defined herein, even in the event of a total loss of power to the control gear 10.

During recording of data in the event of power loss, the microprocessor 12 may be arranged to provide power to the control gear 10 for a short period (typically a fraction of a second) after generation of the power loss signal. The power loss signal may be treated in the microprocessor 12 as a high priority interrupt, thereby permitting the recording of the latest usage data in the non-volatile memory device 16 before power in the electronic control gear 10 decays entirely.

A further refinement possible in the electronic control gear 10 of the invention is to provide within the microprocessor 12 a software counter that increments periodically, for example, once an hour or once every 24 hours in order to record the total usage of the control gear 10.

Overall the apparatus of the invention is advantageously inexpensive and simple to embody.

Data from the memory device 16 may be downloaded using the wiring of the lighting network. To this end, the microprocessor 12 may allocate identifier or flag bits to each string of data, so as uniquely to identify the lamp 11 and/or electronic control gear 10 with which it is associated.

As noted, it is not necessary that both the power sensor 17 and the temperature sensor 18 are present in embodiments of the invention as defined herein. In the absence of one or other of these components, therefore, operation of the electronic control gear 10 is of course modified in ways that would be within the knowledge of the worker of ordinary skill in the relevant art.

A control gear 10 is hereby provided that hereinabove advantageously permits a supplier of electronic control gears to establish, unequivocally, whether a warranty claim from an operator of area or street lighting apparatuses is justified or is the result of incorrect use of electronic ballasts (for example including extended use at excessive ambient temperatures). The control gear 10 also permits an operator of area or street lighting to obtain data which justify a power cost reduction or which show that networks are being operated within the terms of power supply agreements. Further, the control gear 10 conveniently permits the recording of ambient temperature data using an electronic “package” that is compact.

1-17. (canceled)

18. An electronic control gear for a lamp, the electronic control gear comprising:
a memory device; and
a microprocessor configured to acquire data relating to at least one parameter of operation of the lamp and configured to store acquired data in the memory device;
wherein the at least one parameter of operation is an electrical power consumption of the lamp during a period of operation, a duration of operation of the lamp during a period, a duration of operation the lamp at each of a plurality of power consumption levels or bands, or an operating temperature of a component of a circuit in which the lamp is connected.

19. The electronic control gear according to claim 18, wherein the microprocessor comprises an electronic ballast that controls a supply of electrical power to the lamp.

20. The electronic control gear according claim 18, further comprising:
a temperature sensor operatively connected to the microprocessor, the electronic control gear being configured to record, during operation of the lamp, data from the temperature sensor related to an ambient temperature surrounding the microprocessor.

21. The electronic control gear according to claim 18, further comprising:
an electrical power sensor operatively connected to the microprocessor, the electronic control gear being configured to record, during operation of the lamp, data from the electrical power sensor related to the electrical power consumption of the lamp.

22. The electronic control gear according to claim 21, wherein the electrical power sensor provides data on the duration of operation of the lamp at each of a plurality of power consumption levels or bands to the microprocessor.

23. The electronic control gear according to claim 18, wherein the microprocessor comprises a clock that generates periodic and the microprocessor allocates selected clock pulse signals to define a counter that measures the duration of operation of the lamp the at least one parameter of operation.

24. The electronic control gear according to claim 18, wherein the memory device comprises a non-volatile memory.

25. The electronic control gear according to claim 18:
wherein the microprocessor comprises a clock that generates periodic clock pulse signals and the microprocessor allocates selected clock pulse signals to define a counter that measures the duration of operation of the lamp the at least one parameter of operation;
wherein the memory device comprises a non-volatile memory; and
wherein the microprocessor causes the clock pulse signals to initiate storage of data in the non-volatile memory at predetermined intervals.

26. The electronic control gear according to claim 18, further comprising:
an electrical power sensor operatively connected to the microprocessor, the electronic control gear being configured to record, during operation of the lamp, data from the electrical power sensor related to the electrical power consumption of the lamp;
wherein the memory device comprises a non-volatile memory; and
wherein the electrical power sensor is capable of generating a power loss signal that is indicative of a loss of an incoming mains power to the lamp and transmitting the power loss signal to the microprocessor which causes the storing of data in the non-volatile memory on receipt of the power loss signal.

27. The electronic control gear according claim 18, wherein the lamp is a gas discharge lamp.

28. A method of controlling a lamp, comprising the steps of:
supplying electrical power to the lamp; and
simultaneously recording data relating to at least one of an electrical power consumption of the lamp during a period of operation, a duration of operation of the lamp, a duration of operation of the lamp at each of a plurality of power consumption levels or bands, and an operating temperature of a component of a circuit in which the lamp is connected,
wherein the method includes the step of causing a microprocessor to effect storage of the data in a memory device.

29. The method according to claim 28, further comprising the step of:
operating a temperature sensor operatively connected to the microprocessor to permit recording of data from the temperature sensor related to an ambient temperature surrounding the microprocessor during operation of the lamp.

30. The method according to claim 28, further comprising the step of:
operating an electrical power sensor that is operatively connected to the microprocessor to permit recording of data from the electrical power sensor related to the electrical power consumption of the lamp during operation of the lamp.

31. The method according to claim 30 wherein the electrical power sensor provides data on the duration of operation of the lamp at each of the plurality of power consumption levels or bands to the microprocessor.

32. The method according to claim 28, wherein the microprocessor comprises a clock that generates periodic clock pulse signals and the method further comprises the step of causing the microprocessor to allocate selected clock pulse signals to define a counter that measures the duration of operation of the lamp.

33. The method according to claim 32, wherein the memory device includes a non-volatile memory and wherein the method further comprises the step of operating the microprocessor to cause the clock pulse signals to initiate storage of data in the non-volatile memory at predetermined intervals.

34. The method according to claim 28, further comprising:
operating an electrical power sensor that is operatively connected to the microprocessor to permit recording of data from the electrical power sensor related to the electrical power consumption of the lamp during operation of the lamp;
wherein the memory device comprises a non-volatile memory; and
wherein the electrical power sensor is capable of generating a power loss signal that is indicative of a loss of an incoming mains power to the lamp; and
wherein the method further comprises the step of transmitting the power loss signal to the microprocessor to cause the storing of data in the non-volatile memory on receipt of the power loss signal.
